(19) United States
(12) Patent Application Publication
(10) Pub. No.: US 2018/0058572 A1
(43) Pub. Date: Mar. 1, 2018

(54) MULTIPLEXED PRESSURE SENSOR FOR VEHICLE TRANSMISSION CONTROL

(71) Applicant: FORD GLOBAL TECHNOLOGIES, LLC, Dearborn, MI (US)

(72) Inventor: Bradley Ronald HEUVER, South Lyon, MI (US)

(21) Appl. No.: 15/254,337

(22) Filed: Sep. 1, 2016

(51) Int. Cl. F16H 61/02; F16D 13/52; F16D 13/38; F16D 25/0638; F16D 48/06; F16D 48/02

(52) U.S. Cl. CPC F16H 61/0204; F16D 13/52; F16D 13/385; F16H 3/66; F16D 48/06; F16D 48/02; F16D 25/0638

(57) ABSTRACT

A multiplexed sensor for determining pressures of two different chambers of a clutches is provided, utilizing real-time pressure of a balance chamber of a clutch to control that clutch. The transmission includes a balance dam fixed with respect to a clutch housing. The clutch is compressible in a direction away from the balance dam by a piston. The balance dam and the piston define a balance chamber therebetween. An apply chamber is located on the opposite side of the balance dam, and is configured to apply or supply pressurized fluid to the clutch pack. A multiplexed pressure sensor is in fluid communication with the balance chamber and the apply chamber. A controller is programmed to control the clutch based on a pressure in the apply chamber and the balance chamber depending on, for example, which pressure is greater.

### TECHNICAL FIELD

This disclosure generally relates to an automatic transmission in a vehicle. This disclosure more particularly relates to a multiplexed pressure sensor for reading multiple fluid pressures simultaneously for more accurate control of clutches in the transmission.

### BACKGROUND

Many vehicles are used over a wide range of vehicle speeds, including both forward and reverse movement. Some types of engines, however, are capable of operating efficiently only within a narrow range of speeds. Consequently, transmissions capable of efficiently transmitting power at a variety of speed ratios are frequently employed. When the vehicle is at low speed, the transmission is usually operated at a high speed ratio such that it multiplies the engine torque for improved acceleration. At high vehicle speed, operating the transmission at a low speed ratio permits an engine speed associated with quiet, fuel efficient cruising. Typically, a transmission has a housing mounted to the vehicle structure, an input shaft driven by an engine crankshaft, and an output shaft driving the vehicle wheels, often via a differential assembly which permits the left and right wheel to rotate at slightly different speeds as the vehicle turns.

A common type of automatic transmission utilizes a collection of clutches and brakes. Various subsets of the clutches and brakes are engaged to establish the various speed ratios. A common type of clutch utilizes a clutch pack having separator plates splined to a housing and interleaved with friction plates splined to a rotating shell. When the separator plates and the friction plates are forced together, torque may be transmitted between the housing and the shell. Typically, a separator plate on one end of the clutch pack, called a reaction plate, is axially held to the housing. The piston applies axial force to a separator plate on the opposite end of the clutch pack, called a pressure plate, compressing the clutch pack. The piston force is generated by supplying pressurized fluid to an apply chamber between the housing and the piston. For a brake, the housing may be integrated into the transmission case. For a clutch, the housing rotates. As the pressurized fluid flows from the stationary transmission case to the rotating housing, it may need to cross one or more interfaces between components rotating at different speeds. At each interface, seals direct the flow from an opening in one component into an opening in the interfacing component.

When a clutch housing rotates when the clutch is open, fluid in the apply chamber may be pressurized by centrifugal force. To prevent this force from engaging the clutch, unpressurized fluid may be routed to a balance chamber 120 on the opposite side of piston from the apply chamber.

### SUMMARY

In one embodiment, a transmission includes a balance dam fixed with respect to a clutch housing. A clutch pack is compressible in a direction away from the balance dam by a piston, the balance dam and the piston defining a balance chamber therebetween. A pressure sensor is configured to output a signal representing fluid pressure in the balance chamber. A controller is programmed to control the clutch based on the signal.

In another embodiment, a transmission includes a balance chamber bound by a balance dam of a clutch and configured to receive unpressurized fluid from the clutch when open. An apply chamber of the clutch is configured to apply fluid pressure to close the clutch. A pressure sensor has a first inlet in selective fluid communication with the balance chamber, and a second inlet in selective fluid communication with the apply chamber.

In another embodiment, a method of controlling an automotive transmission includes receiving unpressurized fluid in a balance chamber, supplying pressurized fluid to an apply chamber of a clutch, and alternately controlling the clutch based on fluid pressures in the balance chamber and the apply chamber.

### BRIEF DESCRIPTION OF THE DRAWINGS

FIG. 1 is a schematic representation of a transmission gearing arrangement, according to one embodiment.

FIG. 2 is one embodiment of a cross sectional view of a two clutch module suitable for use in the transmission gearing arrangement of FIG. 1.

FIG. 3 is a perspective view of a multiplexed fluid pressure sensor mounted within a vehicle transmission, according to one embodiment.

FIG. 4 is a perspective view of the fluid lines that lead to the pressure sensor of FIG. 3, which is removed.

FIG. 5 is a perspective view of a plurality of ball valves for switching hydraulic feeds to the pressure sensor, according to one embodiment.

FIG. 6 is a schematic representation of another gearing arrangement of a transmission in which the pressure sensor can be utilized, according to one embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Words of direction (e.g., “left,” “right,”) should be understood to be relative to the orientation shown in the Figures that are being described. For example, when it is said that a clutch plate moves the “left,” it should be understood that this is intended to mean that the clutch in the certain figure being described moves to the left in the orientation of that Figure.

A gearing arrangement is a collection of rotating elements and shift elements configured to impose specified speed relationships among the rotating elements. Some speed relationships, called fixed speed relationships, are imposed regardless of the state of any shift elements. Other speed relationships, called selective speed relationships, are imposed only when particular shift elements are fully engaged. A linear speed relationship exists among an ordered list of shafts when i) the first and last shaft in the ordered list are constrained to have the most extreme speeds, ii) the speeds of the remaining shafts are each constrained to be a weighted average of the speeds of the first and last shafts, and iii) when the speeds of the shafts differ, they are constrained to be in the listed order, either increasing or decreasing. A discrete ratio transmission has a gearing arrangement that selectively imposes a variety of speed ratios between an input shaft and an output shaft.

A group of rotating elements are fixedly coupled to one another if they are constrained to rotate as a unit in all operating conditions. Rotating elements can be fixedly coupled by spline connections, welding, press fitting, machining from a common solid, or other means. Slight variations in rotational displacement between fixedly coupled elements can occur such as displacement due to lash or shaft compliance. In contrast, two rotating elements are selectively coupled by a shift element when the shift element constrains them to rotate as a unit whenever it is fully engaged and they are free to rotate at distinct speeds in at least some other operating condition. A shift element that holds a rotating element against rotation by selectively connecting it to the housing is called a brake. A shift element that selectively couples two or more rotating elements to one another is called a clutch. Shift elements may be actively controlled devices such as hydraulically or electrically actuated clutches or brakes or may be passive devices such as one way clutches or brakes.

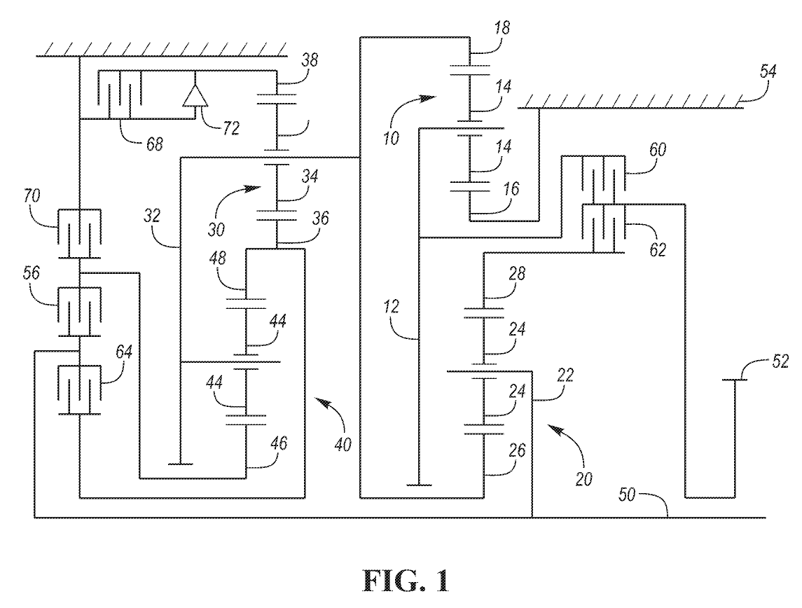

FIG. 1 schematically illustrates the gearing arrangement of a transmission gearbox. The transmission utilizes four simple planetary gear sets 10, 20, 30, and 40. Each simple planetary gear set includes a planet carrier that rotates about a central axis and supports a set of planet gears such that the planet gears rotate with respect to the planet carrier. External gear teeth on the planet gears mesh with external gear teeth on sun gears and with internal gear teeth on ring gears. The sun gear and ring gear are also supported to rotate about the central axis. To reduce axial length, gear set 10 is positioned radially outside and in a common plane with gear set 20. Similarly, gear set 30 is positioned radially outside of gear set 40. Gear sets 30 and 40 share a common carrier 32 but have separate planet gears 34 and 44.

A simple planetary gear set is a type of gearing arrangement that establishes a fixed linear speed relationship among the sun gear, the carrier, and the ring gear. Other known types of gearing arrangements also establish a fixed linear speed relationship among three rotating elements. For example, a double pinion planetary gear set establishes a fixed linear speed relationship among the sun gear, the ring gear, and the carrier. A suggested ratio of gear teeth for each planetary gear set is listed in Table 1.

TABLE 1

| | |
|---|---|
| Ring 18/Sun 16 | 1.467 |
| Ring 28/Sun 26 | 1.927 |
| Ring 38/Sun 36 | 1.658 |
| Ring 48/Sun 46 | 1.712 |

Sun gear 16 is fixedly held against rotation; carrier 22 is fixedly coupled to input 50; sun gear 36 is fixedly coupled to ring gear 48; and common carrier 32, ring gear 18, and sun gear 26 are mutually fixedly coupled. Output 52 is selectively coupled to carrier 12 by clutch 60 and selectively coupled to ring gear 28 by clutch 62. Input 50 is selectively coupled to the combination of sun gear 36 and ring gear 48 by clutch 64. Sun gear 46 is selectively coupled to input 50 by clutch 66 and selectively held against rotation by brake 70. Ring gear 38 is selectively held against rotation by brake 68. One-way-brake 72 passively precludes the ring gear 38 from rotating in a reverse direction while permitting rotation in a positive direction.

Various subsets of the gearing arrangement of FIG. 1 establish particular speed relationships. Gear sets 30 and 40 collectively establish a linear speed relationship among sun gear 46, ring gear 38, common carrier 32, and the combination of sun gear 36 and ring gear 48. Any gearing arrangement having two planetary gear sets with two elements of the first gear set fixedly coupled to two respective elements of the second gear set fixedly establishes a linear speed relationship among the resulting four shafts. Gear sets 30 and 40 are linked to gear sets 10 and 20 by an intermediate shaft that includes common carrier 32, ring gear 18, and sun gear 26. Gear sets 30 and 40 in combination with clutches 64 and 66 and brakes 68 and 70 selectively establish several proportional speed relationships. When brake 70 is engaged, the first shaft is held against rotation. When clutch 66 and brake 68 are engaged, a reverse speed relationship is established between the input and the intermediate shaft. When brakes 68 and 70 are both engaged, the intermediate shaft is held against rotation. When clutch 64 is engaged in combination with either brake 68 or brake 70, underdrive speed relationships are established between the input and the intermediate shaft. Finally, when clutches 64 and 66 are both engaged, the input and the intermediate shaft rotate as a unit. Gear set 10 fixedly establishes an underdrive speed relationship between the intermediate shaft and carrier 12.

Engaging the shift elements as shown in Table 2 establishes nine forward speed ratios and one reverse speed ratio between input 50 and output 52. An X indicates that the shift element must be engaged to establish the power transfer path. An (X) indicates that the shift element is not required to establish the power path, but may be engaged to facilitate shifts to other ratios. When the gear sets have tooth numbers as indicated in Table 1, the speed ratios have the values indicated in Table 2.

TABLE 2

| | 60 | 62 | 64 | 66 | 68/72 | 70 | Ratio | Step |
|---|---|---|---|---|---|---|---|---|
| Rev | X | | | X | X | | −3.09 | 69% |
| 1st | X | | X | | X | | 4.47 | |
| 2nd | X | | X | | | X | 2.66 | 1.68 |
| 3rd | X | | X | X | | | 1.68 | 1.58 |
| 4th | X | X | (X) | | | | 1.23 | 1.36 |
| 5th | | X | X | X | | | 1.00 | 1.23 |
| 6th | | X | X | | | X | 0.84 | 1.19 |
| 7th | | X | X | | X | | 0.76 | 1.11 |
| 8th | | X | | | X | X | 0.66 | 1.15 |
| 9th | | X | | X | X | | 0.56 | 1.19 |

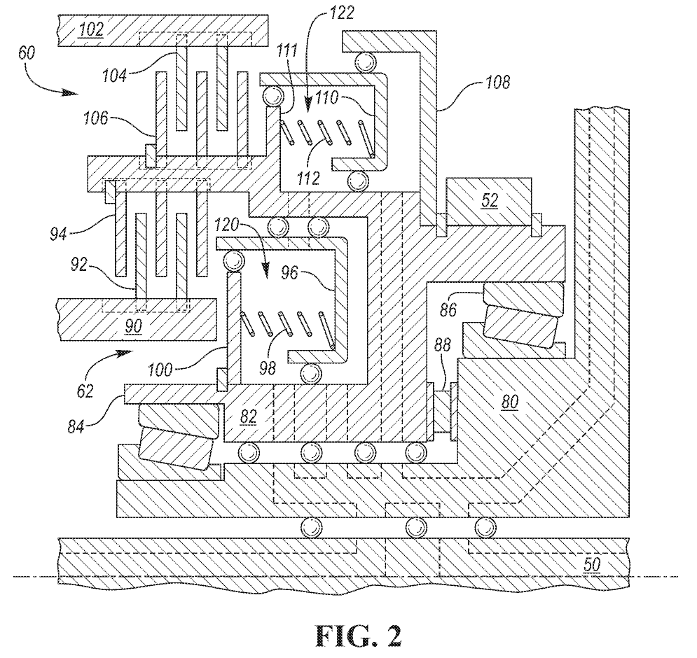

FIG. 2 illustrates the construction of clutches 60 and 62 in more detail. These two clutches may be constructed as a two clutch module suitable for assembly and test as a sub-assembly. Front support 80 is rigidly mounted to transmission case 54. Clutch housing 82 is supported for rotation about front support 80 by bearings 84 and 86. Bearings 84 and 86 are separated axially which reduces the bearing forces required to react a given bending moment. The separation between the bearings also provides space for fluid to flow from the front support to the clutch housing between these bearings. Clutch housing 82 is restrained from axial movement by thrust bearing 88.

Clutch hub 90 is fixedly coupled to ring gear 28. A set of friction plates 92 are splined to clutch hub 90 at their inner diameter such that the friction plates rotate with the clutch hub but are free to slide axially. Friction plates 92 are interleaved with a set of separator plates 94. Each separator plate is splined to the clutch housing 82 at its outer diameter such that the separator plates rotate with the clutch housing but are free to slide axially. The separator plate on the left end, which may be called a reaction plate, is held in place axially by a snap ring. To apply clutch 62, pressurized fluid is routed from a valve body, into the front support, into the clutch housing, and then into an apply chamber, located between clutch housing 82 and piston 96 (i.e., to the right of the piston 96). As the fluid passes from front support 80 to clutch housing 82, seals ensure that the fluid flows to the correct passageway in the clutch housing. In response to the pressurized fluid, piston 96 slides to the left and squeezes the friction plates 92 between the separator plates 94. Friction between the friction plates and separator plates forces clutch hub 90 to rotate at the same speed as clutch housing 82. When the fluid pressure is relieved, return spring 98 forces piston 96 to the right to open the clutch and unfix the relative motion between the friction plates and the separator plates.

Return spring 98 reacts against a balance dam 100 which is constrained from moving axially with respect to clutch housing 82 by a snap ring, for example. When clutch housing 82 rotates when the clutch 62 is open, fluid in the apply chamber is pressurized by centrifugal force. To prevent this force from engaging the clutch, unpressurized fluid is routed to a balance chamber 120 on the opposite side of piston 96 (i.e., to the left of piston 96; between the piston 96 and balance dam 100). As will be described below, a pressure sensor can be in fluid communication with the balance chamber 120 to detect the fluid pressure in the chamber 120 even when the clutch 62 is open. The pressure sensor can be multiplexed to detect pressures of multiple chambers, such as the balance chamber and the apply chamber. A check ball valve (described below) is an example of a type of valve that can allow the sensor to measure pressure of the greater of two pressures acting on the check ball valve. This allows the control of a single clutch to be based on the greater of the pressures of two different chambers.

Clutch 60 is structured similarly to clutch 62. Clutch hub 102 is fixedly coupled to carrier 12. Friction plates 104 are splined to clutch hub 102 at their outer diameter and are interleaved with separator plates 106 which are splined to clutch housing 82 at their inner diameter. To apply clutch 60, pressurized fluid is routed from a valve body, into the front support, into the clutch housing, and then into an apply chamber between cap 108 and piston 110. Return spring 112 forces piston 110 to the right (in FIG. 2) when pressure is removed. Unpressurized fluid is routed from the clutch 62 to a balance chamber 122 which is located on the opposite side of the piston 110 from the apply chamber (i.e., to the left of the piston 110; between the piston 110 and the balance dam 111). The routing of unpressurized fluid into the balance chamber 122 can be, for example, via a hole in piston 96, through a passageway in clutch housing 82, and into the balance chamber 122.

The balance chambers 120, 122 can be fluidly coupled to one another via a passage.

As mentioned, the balance chambers 120, 122 are used for receiving a portion of the fluid when the clutch is open, to assure the centrifugal force does not undesirably close the clutch. For example, the fluid in the balance chamber 120 has a centrifugal pressure generated therein, which urges the piston 96 to the left. However, this leftward urging of the piston 96 will be balanced by the centrifugal pressure generated within the fluid in the apply chamber (i.e., to the right of the piston 96). Thus, the centrifugal pressures are balanced, and the pistons 96 will not be subject to axial forces resulting from the centrifugal pressures.

Typically, a sensor is fluidly coupled to a respective one of the apply chambers. These sensors are used by the controller for preventing misdirection by assuring that the pressure in the apply chambers are as expected for the given vehicular travel direction when the clutch is closed. These sensors are not typically used for the vast majority of the time after the vehicle is moving in the intended direction. When the clutch is open, these pressure sensors are typically not used.

According to the present disclosure, a system is provided that utilizes a pressure sensor that can detect the pressure of the apply chamber and the balance chamber, and an associated controller that can control the clutch based on the pressures of both chambers. In one embodiment, the pressure of the balance dam of one open clutch can help control the operation of another clutch. When a first clutch is open and not applied, the fluid pressure in the balance dam of that clutch can be used to increase the accuracy of the control of a second clutch. The sensor can be multiplexed to read pressures of two chambers (e.g., the balance chamber of one clutch and the apply chamber of that clutch). The balance chambers of two clutches can be fluidly coupled, such that the control of one clutch can be based on the fluid pressure of the balance chamber of another clutch, even when that another clutch is open. In a single housing, two discrete sensors may be present, each able to detect fluid of a respective fluid chamber or fluid line. By multiplexing the sensor, the transmission can switch which pressure is being read, with the greater of the pressures being connected to each sensor. These pressure readings can be used by the controller for more accurate clutch management.

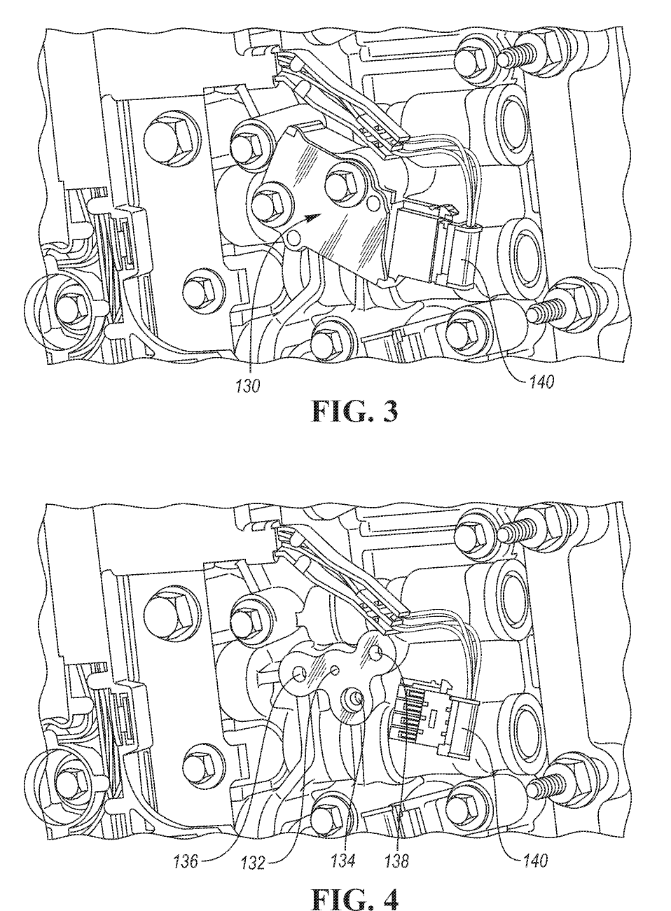

FIG. 3 is a perspective view of a multiplexed fluid pressure sensor 130 attached to the transmission housing, and FIG. 4 is a perspective view of the hydraulic feeds (with the sensor and associated housing removed) that communicate fluid to the sensor 130 for pressure readings. A first sensor inlet 132 communicates with a first hydraulic feed. The first hydraulic feed transfers fluid from a first fluid chamber, such as the balance chamber 120. A second sensor inlet 134 communicates with a second hydraulic feed. The second hydraulic feed transfers fluid from a second fluid chamber, such as the apply chamber of clutch 60 or the balance chamber 122 of the other clutch. Other inlets may also be provided. The two or more inlets 132, 134 allow the sensor to be multiplexed and able to read fluid pressures of two fluid chambers, and, in the event the balance dams of two clutches are fluidly coupled, the fluid pressures of two distinct clutches. When the pressure of one fluid chamber exceeds that of another fluid chamber, the greater of the fluid pressures is detected by the pressure sensor. A pair of bolt holes 136, 138 are provided to mount the sensor and associated housing to the transmission. An electrical connection 140 is also provided to transfer the fluid pressure data to an associated transmission controller.

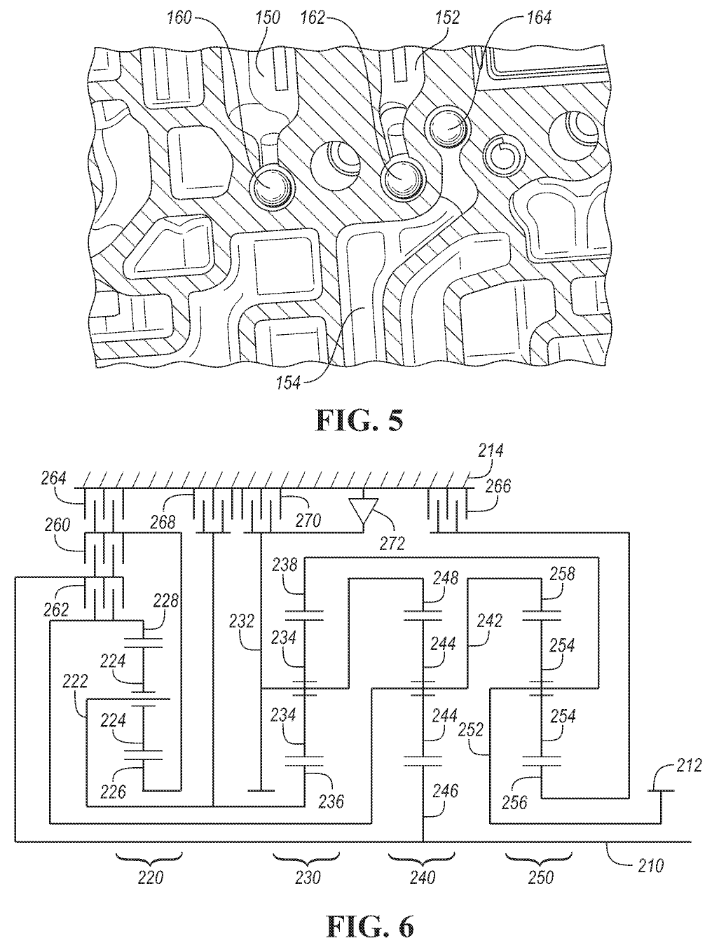

FIG. 5 illustrates a plurality of hydraulic feeds 150, 152, 154 that supply fluid to the pressure sensor 130. Each hydraulic feed connects to a respective fluid chamber of a clutch (e.g., an apply chamber or a balance chamber). At the end of each hydraulic feed 150, 152, 154 is a respective ball valve 160, 162, 164. Each ball valve includes a ball that rests in a pocket or depression to selectively open and close the fluid connection between the hydraulic feeds 150, 152, 154 and the fluid receptacles for the sensor 130. When the pressure in the hydraulic feeds 150, 152, 154 exceeds that of the respective fluid receptacle for the sensor 130, the ball vale opens and allows fluid to enter the sensor housing to have its pressure determined. When the pressure in the hydraulic feeds 150, 152, 154 is exceeded by the pressure in the respective fluid receptacle for the sensor 130, the ball valve closes to block the fluid coupling and inhibit pressure detection of that hydraulic feed.

It should be understood that other valves may be utilized that are controlled by a controller to selectively open and close the hydraulic feeds, allowing selective measurement of the fluid pressure.

It should be understood that the transmission gearing arrangement of FIG. 1 is merely exemplary. The disclosure relating to the multiplex sensor and control of the clutches can be applied to other transmissions. FIG. 6 is another embodiment of a transmission in which the multiplex sensor and control can be implemented, wherein one of the sensors disclosed above can be utilized to enable the controller to control one clutch based on the fluid pressure of a balance dam fluid chamber of another clutch. The transmission of FIG. 3 is an eight-speed transmission. According to FIG. 3, input shaft 210 is driven by an internal combustion engine, potentially via a launch device such as a torque converter. Output 212 drives the vehicle wheels, potentially via gearing and a differential. The various components of the gearing arrangement are supported within a transmission case 214 that is fixed to vehicle structure. The transmission utilizes four simple planetary gear sets 220, 230, 240, and 250. A planet carrier 222 rotates about a central axis and supports a set of planet gears 224 such that the planet gears rotate with respect to the planet carrier. External gear teeth on the planet gears 224 mesh with external gear teeth on a sun gear 226 and with internal gear teeth on a ring gear 228. Sun gear 226 and ring gear 228 are supported to rotate about the same axis as the carrier. Gear sets 230, 240, and 250 are similarly structured.

Sun gear 246 is fixedly coupled to input shaft 210. Ring gear 238 and carrier 252 are fixedly coupled to output 212. Carrier 222 is fixedly coupled to sun gear 236. Ring gear 228, carrier 242, and ring gear 258 are mutually fixedly coupled. Carrier 232 is fixedly coupled to ring gear 248. Clutch 262 selectively couples ring gear 228 to input shaft. Sun gear 226 is selectively coupled to input shaft 210 by clutch 260 and selectively held against rotation by brake 264. Brake 266 selectively holds sun gear 256 against rotation. Brake 268 selectively holds carrier 222 and sun gear 236 against rotation. Carrier 232 and ring gear 248 are selectively held against rotation by brake 270 and passively held against rotation in one direction by one way brake 272.

As shown in Table 3, engaging the shift elements in combinations of two establishes eight forward speed ratios and one reverse speed ratio between input shaft 210 and output 212. An X indicates that the shift element is required to establish the speed ratio.

TABLE 3

| | 260 | 262 | 264 | 266 | 268 | 270/272 | Ratio | Step |
|---|---|---|---|---|---|---|---|---|
| Rev | X | | | | | X | −3.79 | 89% |
| 1^{st} | | | | X | | X | 4.26 | |
| 2^{nd} | | | | X | X | | 2.73 | 1.56 |
| 3^{rd} | | | X | X | | | 2.19 | 1.25 |
| 4^{th} | X | | | X | | | 1.71 | 1.28 |
| 5^{th} | | X | | X | | | 1.33 | 1.29 |
| 6^{th} | X | X | | | | | 1.00 | 1.33 |
| 7^{th} | | X | X | | | | 0.85 | 1.18 |
| 8^{th} | | X | | | X | | 0.69 | 1.23 |

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A transmission comprising:
a balance dam fixed with respect to a clutch housing;
a clutch pack compressible in a direction away from the balance dam by a piston, the balance dam and the piston defining a balance chamber therebetween;
a pressure sensor configured to output a signal representing fluid pressure in the balance chamber; and
a controller programmed to control the clutch based on the signal.

2. The transmission of claim 1, further comprising a second clutch, wherein the controller is programmed to control the second clutch based on the signal.

3. The transmission of claim 2, further comprising a second balance dam, wherein the second clutch includes a second clutch pack compressible in a direction away from the second balance dam by a second piston, wherein the second balance dam and the second piston define a second balance chamber therebetween that is in fluid communication with the balance chamber.

4. The transmission of claim 1, further comprising an apply chamber located on an opposing side from the piston relative to the balance dam, wherein the pressure sensor is configured to output a second signal representing fluid pressure in the apply chamber, and the controller is programmed to control the clutch based on the signal and the second signal.

5. The transmission of claim 1, wherein the pressure sensor is a multiplexed sensor configured to output a second signal representing fluid pressure in a fluid chamber of a second clutch.

6. The transmission of claim 5, wherein the signals output from the multiplexed sensor is utilized by the controller to (a) prevent misdirection of the clutch, and (b) measure pressure in the balance chamber during normal operation of the clutch.

7. A transmission comprising:
a balance chamber bound by a balance dam of a clutch and configured to receive unpressurized fluid from the clutch when open;
an apply chamber of the clutch configured to apply fluid pressure to close the clutch; and
a pressure sensor having a first inlet in selective fluid communication with the balance chamber, and a second inlet in selective fluid communication with the apply chamber.

8. The transmission of claim 7, wherein the pressure sensor is multiplexed.

9. The transmission of claim 7, further comprising a controller programmed to control operation of the clutch based on pressure in the balance chamber and the apply chamber, alternately.

10. The transmission of claim 7, wherein the clutch is a first clutch and the transmission further comprises a second clutch and a controller programmed to control the second clutch based on a pressure in the balance chamber when the first clutch is open.

11. The transmission of claim 10, wherein the second clutch includes a second balance chamber bound by a second balance dam of the second clutch, wherein the second balance chamber is fluidly coupled to the balance chamber of the first clutch.

12. A method of controlling an automotive transmission, comprising:
receiving unpressurized fluid in a balance chamber;
supplying pressurized fluid to an apply chamber of a clutch; and
alternately controlling the clutch based on fluid pressures in the balance chamber and the apply chamber.

13. The method of claim 12, wherein the balance chamber is bound by a balance dam of a second clutch.

14. The method of claim 12, further comprising outputting signals representing the fluid pressures via a multiplexed sensor.

15. The method of claim 14, further comprising receiving, at the multiplexed sensor, a greater of the fluid pressures from the apply chamber and the balance chamber.

16. The method of claim 14, further comprising preventing misdirection of the automotive transmission based on the fluid pressure in the balance chamber.

17. The method of claim 12, wherein the balance chamber is bound by a balance dam of the clutch, the method further comprising controlling another clutch based on the fluid pressure in the balance dam.

18. The method of claim 17, wherein the another clutch includes a balance chamber fluidly coupled to the balance chamber.
